(19) United States
(12) Patent Application Publication
(10) Pub. No.: US 2008/0255860 A1
(43) Pub. Date: Oct. 16, 2008

(54) Audio decoding apparatus and decoding method

(75) Inventor: Masataka Osada, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/072,344

(22) Filed: Feb. 26, 2008

(30) Foreign Application Priority Data
Apr. 11, 2007 (JP) 2007-104069

(51) Int. Cl. G10L 21/04

(52) U.S. Cl. 704/503

(57) ABSTRACT

A signal characteristic is detected from a block shape indicating a time/frequency conversion block length by a signal characteristic discrimination unit to discriminate whether the prediction precision in the time domain is high or the prediction precision in the frequency domain is high and, on the basis of a result of the discrimination, a signal correction unit corrects a quantization error in spectral information obtained by de-quantization.

### CROSS-REFERENCE TO RELATED APPLICATIONS

This application is based upon and claims the benefit of priority from prior Japanese Patent Application No. 2007-104069, filed Apr. 11, 2007, the entire contents of which are incorporated herein by reference.

### BACKGROUND OF THE INVENTION

1. Field of the Invention

The present invention relates to an audio decoding apparatus decoding encoded audio data.

2. Description of the Related Art

It is known that, in a conventional audio decoding apparatus, distortion occurred on audio data in encoding processing is suppressed to satisfy continuity with an adjacent frequency band when modification on audio data is executed during a decoding processing (cf., for example, Jpn. Pat. Appln. KOKAI Publication No. 2001-102930).

However, an effect of the correction cannot be expected for a signal with strong tone represented by a sinusoidal wave, i.e. a signal having no continuity with the adjacent frequency band.

### BRIEF SUMMARY OF THE INVENTION

The present invention has been accomplished to solve the above-described problems. The object of the present invention is to provide an audio decoding apparatus and a decoding method, capable of suppressing an influence of noise generated at the time of encoding, for a signal having no continuity with a proximate frequency band, and restoring a reproduced sound which is faithful to an original sound.

To achieve this object, an aspect of the present invention comprises a decoding unit which decodes encoded audio data and obtains quantization spectrum, information containing a quantization step size, and a spectral value, a discrimination unit which discriminates a signal characteristic of a time domain of the spectral value, a I-quantizer which inversely quantizes the quantization spectrum and obtains the spectral value, an estimation unit which estimates a range of a level of the spectral value, based on the quantization step size and the spectral value, a correction unit which corrects the spectral value within the range with reference to continuity in time of the spectral value if the discrimination unit discriminates that the signal characteristic in the time domain is stationary, and which corrects the spectral value within the range with reference to continuity in frequency of the spectral value if the discrimination unit discriminates that the signal characteristic in the time domain is transitional, and a conversion unit which converts the spectral value corrected by the correction unit into a signal in the time domain.

According to the present invention, a signal characteristic of a decoded signal is detected to discriminate whether the prediction precision in the time domain is high or the prediction precision in the frequency domain is high and, on the basis of a result of the discrimination, a signal correction unit 60 corrects a quantization error in spectral information obtained by de-quantization.

Therefore, according to the present invention, if a signal has no continuity with a proximate frequency band, the quantization error is corrected by the prediction in the time domain. Thus, the present invention can provide an audio decoder and a decoding method, capable of restoring a reproduced sound which is faithful to the original sound, by suppressing an influence of noise generated at the time of decoding, for the signal having no continuity with a proximate frequency band.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a block diagram of a configuration of an audio decoder according to a first embodiment of the present invention;

FIG. 2 shows a graph of an operation of selecting a quantization step size in an encoder;

FIG. 3 shows a graph of an operation of estimating a quantization error range in the audio decoder shown in FIG. 1;

FIG. 4 shows graphs of an operation of correcting a signal level in the audio decoder shown in FIG. 1;

FIG. 5 shows graphs of an operation of correcting a signal level in the audio decoder shown in FIG. 1;

FIG. 6 shows a block diagram of a configuration of an audio decoder according to a second embodiment of the present invention; and

FIG. 7 shows a block diagram of a configuration of an audio decoder according to a third embodiment of the present invention.

### DETAILED DESCRIPTION OF THE INVENTION

Embodiments of the present invention will be described with reference to the accompanying drawings.

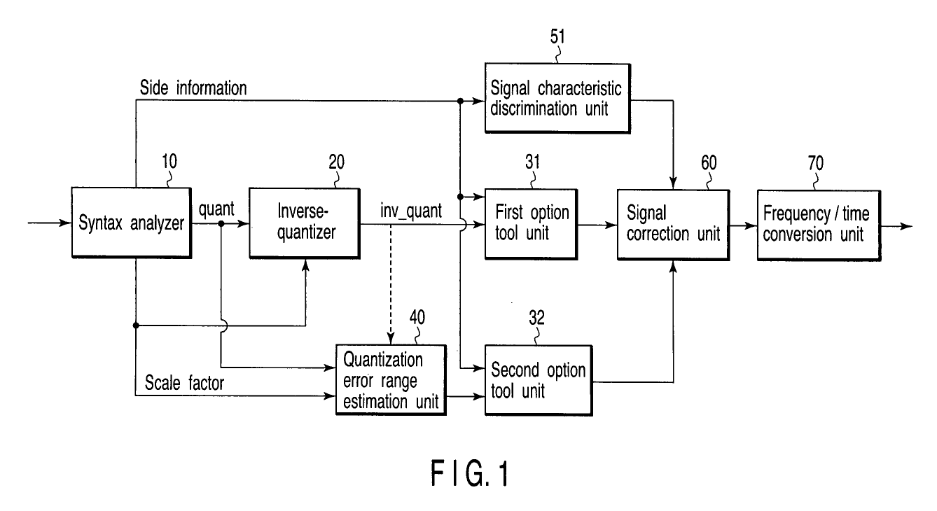

FIG. 1 shows a configuration of an audio decoding apparatus according to a first embodiment of the present invention. The audio decoding apparatus, such as a cellular phone, a PDA, and a portable computer, comprises a syntax analyzer 10, a Inverse-quantizer (I-quantizer) 20, a first option tool unit 31, a second option tool unit 32, an error range estimation unit 40, a signal characteristic discrimination unit 51, a signal correction unit 60 and a frequency/time conversion unit 70. In the following descriptions, AAC (Advanced Audio Coding) is employed as the encoding system, but the present invention can also be applied to an audio decoding apparatus employing the other general encoding method such as MP3 or SBC (Sub-band coding).

The syntax analyzer 10 decodes an input bit stream, such as TS packets containing coded audio data, to obtain the side information indicating whether an option tool is used or not, the block shape representing a time-frequency conversion block length and the like, and decodes the Huffman codes included in the bit stream to obtain a quantization spectrum, which may be called quantized coefficients, (quant) generated by quantizing the original signal in each frequency band and a scale factor regarded as gain information representing the quantization step size of each spectrum.

The I-quantizer 20 I-quantizes the quantization spectrum obtained by the syntax analyzer 10. In other words, the I-quantizer 20 extends the dynamic range by multiplying the quantization spectrum by the scale factor, and obtains spectrum information (inv_quant) having the dynamic range of the original signal (signal to be encoded).

If AAC is employed as the encoding method, the I-quantization executed by the I-quantizer 20 is provided in formula (1). In the formula (1), quant[i] represents a quantization value subjected to Huffman decoding in the syntax analyzer 10, inv_quant[i] represents an MDCT coefficient obtained by multiplying quant[i] by a scale factor contribution and I-quantizing the multiplication result, “i” represents an index of the MDCT coefficient, and SF_OFFSET represents fixed value 100.

inv_quant[i]=Sign(quant[i])·|quant[i]|^{4/3}×2^{1/4·(scale}^{_{—}}^{factor[sfb]-SF}^{_{—}}^{OFFSET)} (1)

The first option tool unit 31 executes a joint stereo process such as M/S stereo, Intensity stereo, and the like and a process of TNS (cf. ISO/IEC 13818-7), for the spectrum information obtained by the I-quantization in the I-quantizer 20, on the basis of the side information obtained by the syntax analyzer 10.

The error range estimation unit 40 calculates, for each frequency band, a level error range from the original signal (hereinafter called a quantization error range), as generated in the quantization spectrum at the quantizing processing on an audio encoding apparatus, on the basis of the quantization spectrum in each of the frequency bands Huffman-decoded by the syntax analyzer 10 and the scale factor thereof.

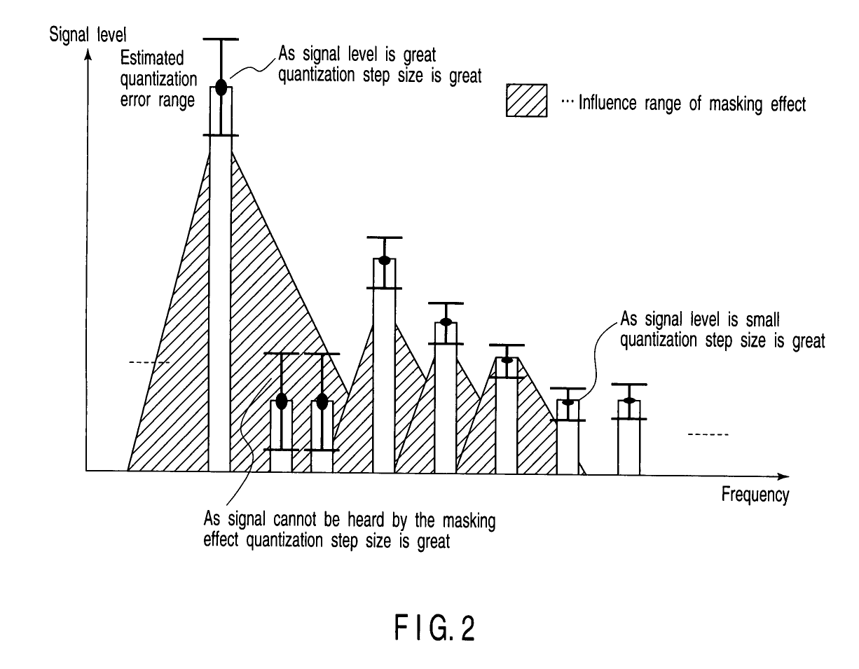

In general, in the audio encoding processing, for each frequency band, one of a plurality of quantization step sizes can be selected, and the quantization step size tends to be greater as the signal level is higher. As shown in FIG. 2, even if the signal level is low, a relatively great quantization step size can be selected in consideration of the masking effect. In consideration of such a selection characteristic of the quantization step size on the audio encoding apparatus, the error range estimation unit 40 can estimate the quantization error range from the quantization step size such as the scale factor. The estimation will be described below more specifically.

“quant[i]” of the formula (1) is in a range from quant[i]−0.5 to quant[i]+0.5, on the audio encoding apparatus. For this reason, the MDCT coefficient to be encoded, i.e. the quantization error range is in a range represented in formula (2). In the formula (2), the right side of the formula (1) is IQ(sfb, quant[i]).

IQ(sfb, quant[i]−0.5)≦inv_quant_{—}org[i]≦IQ(sfb, quant[i]+0.5) (2)

Therefore, the error range estimation unit 40 can estimate the quantization error range for each spectrum by preliminarily storing the formula (2) and applying the quantization spectrum (quant[i]) for each frequency band as Huffman-decoded in the syntax analyzer 10 and the scale factor (scale_factor[sfb]) thereof to the formula (2).

As for another method of estimating the quantization error range by the error range estimation unit 40, a derivative obtained by differentiating the formula (1) with respect to quantization spectrum (quant) can be used. The derivative of the formula (1) is represented below in formula (3).

$$error [ i ] = \frac{4}{3} \cdot {\vert quant [ i ] \vert}^{1 / 3} \times {2}^{1 / 4 \cdot ( scale\_factor [ sfb ] - SF\_OFFSET )} \qquad ( 3 )$$

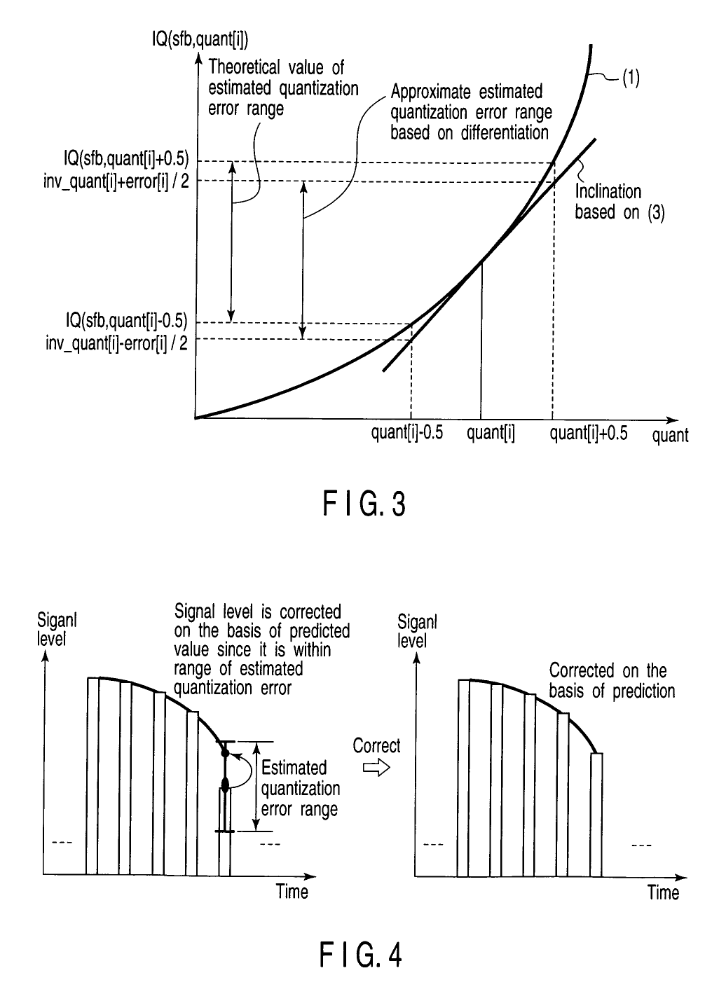

In this method, the error range estimation unit 40 approximately estimates the quantization error range of each spectrum by utilizing preliminarily stored formula (4) obtained by considering the formula (3) and the range of “quant[i]” on the audio encoding apparatus, “quant[i]−0.5 to quant[i]+0.5”, and substituting the Huffman-decoded quantization spectrum (quant[i]), the scale factor thereof (scale_factor[sfb]), and the spectrum information (inv_quant) output from the I-quantization unit 20 for the formula (4). A relationship between the formula (1) and the formula (3) is shown in FIG. 3.

inv_quant[i]−error[i]/2≦inv_quant_{—}org[i]≦inv_quant[i]+error[i]/2 (4)

To estimate the quantization error range based on the formula (2), the operation of the formula (1) needs to be executed at two times, whereas based on the formula (4), the operation of the formula (3) needs to be executed only at one time. The latter algorithm has a great effect for reduction of the operation amount, in consideration of the fact that one frame includes 1024 MDCT coefficients and the quantization error range should be obtained for each of the MDCT coefficients.

The second option tool unit 32 executes a joint stereo process such as M/S stereo, Intensity stereo, and the like and a process of TNS (cf. ISO/IEC 13818-7), for the quantization error range obtained by the error range estimation unit 40, on the basis of the side information obtained by the syntax analyzer 10.

If the block information contained in the side information obtained by the syntax analyzer 10 indicates a long block, the signal characteristic discrimination unit 51 discriminates that the signal characteristic of the current frame is stationary in the time domain. If the block information is a short block, the signal characteristic discrimination unit 51 discriminates that the signal characteristic of the current frame is transitional in the time domain. Then, the signal characteristic discrimination unit 51 notifies the signal correction unit 60 of the discrimination result indicating the signal characteristic.

The signal correction unit 60 corrects the quantization error, for the signal output from the second option tool unit 32, on the basis of the signal characteristic obtained by the discrimination of the signal characteristic discrimination unit 51 and the quantization error range output from the second option tool unit 32.

It is known that, in general, the prediction precision in the time domain is high if the signal is stationary in the time domain, while the prediction precision in the frequency domain is high if the signal is transitional in the time domain. For this reason, if the discrimination result of the signal characteristic discrimination unit 51 indicates the stationary signal characteristic (the block shape is the long block) in the time domain, the signal correction unit 60 predicts the spectrum information of the current frame from the spectrum information of the previous frame. On the other hand, if the discrimination result of the signal characteristic discrimination unit 51 indicates the transitional signal characteristic (the block shape is the short block) in the time domain, the signal correction unit 60 executes correction considering or with reference to the continuity in the frequency domain since the signal has a high prediction precision in the frequency domain.

First, a case where the discrimination result of the signal characteristic discrimination unit 51 indicates the stationary signal characteristic (the block shape is the long block) in the time domain, i.e. the spectrum information of the current frame is predicted from the spectrum information of the previous frame, is described. The signal correction unit 60 comprises a buffer which temporarily stores the spectrum information of a plurality of frames.

A method of prediction and correction based on the spectrum information of the previous m frames is described below. In a apparatus which can read out the bit stream from its storage storing the bet stream in advance, a future frame, i.e. a subsequent frame which follows the current frame to be corrected, can be effectively used for prediction by storing the future frame in the buffer.

To predict the spectrum information of the current frame from the spectrum information of the previous m frames, the signal correction unit 60 executes a linear prediction analysis represented below in formula (5). In the formula (5), “p_quant_{N}[i]” represents a predicted MDCT coefficient of N-th frame. “cor_quant_{N}[i]” represents an MDCT coefficient of corrected N-th frame. “α” represents a linear prediction coefficient. “i” represents a frequency index. As for the linear prediction analysis, it is recommended to refer to general documents such as “Digital Speech Process” (Sadahiro FURUI, published by Tokai University Press).

$${p\_quant}_{N} [ i ] = - {\sum }_{n = 1}^{m} α \cdot {cor\_quant}_{N - k} [ i ] \qquad ( 5 )$$

Then, the signal correction unit 60 executes the correction based on the following process, by considering the spectrum information (p_quant_{N}[i]) predicted in the formula (5) and the quantization error range obtained by the quantization error range estimation unit 40.

In other words, the signal correction unit 60 corrects the predicted spectrum information (p_quant_{N}[i]) of the current frame, by using the quantization error range estimated in the formula (2) or the formula (4). If the corrected MDCT coefficient is defined as “cor_quant[i]”, “cor_quant[i]” must satisfy formula (6).

min_quant[i]≦cor_quant[i]≦max_quant[i] (6)

On the basis of the quantization error range in the formula (2), however, each of the items in the formula (6) is as follows:

min_quant[i]=IQ(sfb,quant[i]−0.5), max_quant[i]=IQ(sfb,quant[i]+0.5)

In addition, on the basis of the quantization error range in the formula (4), however, each of the items in the formula (6) is as follows:

min_quant[i]=inv_quant[i]−error[i]/2, max_quant[i]=inv_quant[i]+error[i]/2

The signal correction unit 60 corrects the MDCT coefficient on the basis of the formula (5) and the formula (6). In other words, if “p_quant[i]” is in the range of the formula (6), the MDCT coefficient is corrected in the following manner.

cor_quant[i]=p_quant_{N}[i]

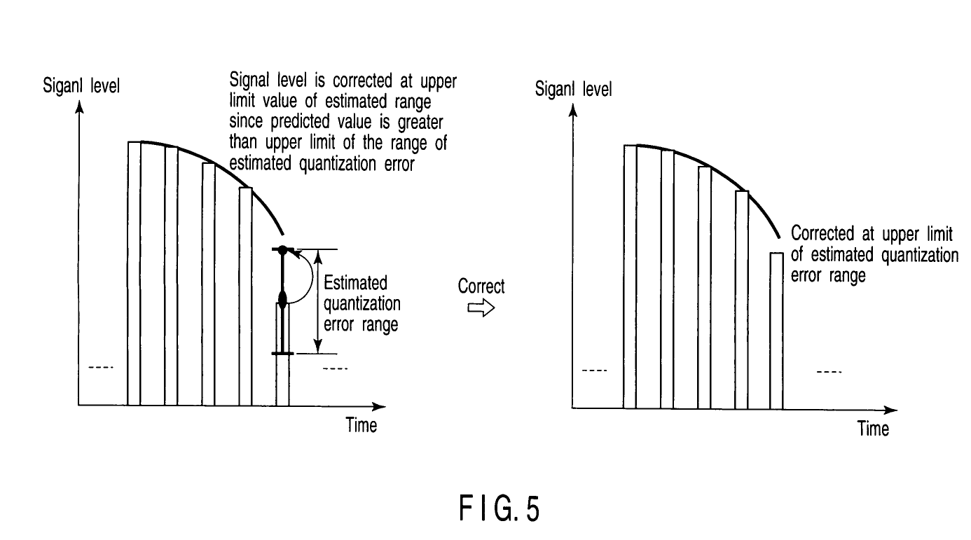

In a case where p_quant[i]<min_quant[i], the MDCT coefficient is corrected in the following manner as shown in FIG. 5.

cor_quant[i]=min_quant_{N}[i]

In a case where p_quant[i]<min_quant[i], the MDCT coefficient is corrected in the following manner.

cor_quant[i]=max_quant_{N}[i]

As described above, if the block shape is the long block, the signal correction unit 60 can restore the signal which is more faithful to the original signal, by correcting the signal of the current signal in consideration of the continuity in the time domain and the theoretical quantization error range.

Next, a case where the discrimination result of the signal characteristic discrimination unit 51 indicates the transitional signal characteristic (the block shape is the short block) in the time domain, i.e. the correction is executed in consideration of the continuity in the frequency domain, is described.

Incidentally, “p_quant_{N}[i]” represents a predicted MDCT coefficient of the current frame, “cor_quant_{N}[i]” represents an MDCT coefficient in the low-frequency side, of the corrected current frame, “k” represents an index of a frequency sample to be predicted, and “i” represents an index of a frequency sample to be used for the prediction. As represented below in formula (7), a high-frequency spectrum is subjected to the linear prediction analysis on the basis of the spectrum information of low-frequency L sample. However, prediction on both the low-frequency side and the high-frequency side is also effective.

$$p\_quant [ k ] = - {\sum }_{i = k - L - 1}^{k - 1} α \cdot cor\_quant [ i ] \qquad ( 7 )$$

The corrected MDCT coefficient (cor_quant[i]) must satisfy the formula (6), similarly to the above-described process in the long block. Therefore, the predicted MDCT coefficient is corrected on the basis of the formula (6) and the formula (7) by the signal correction unit 60, similarly to the above-described process in the long block, and the corrected MDCT coefficient (cor_quant[i]) can be thereby obtained.

The frequency/time conversion unit 70 converts the MDCT coefficient corrected by the signal correction unit 60 from the signal in the frequency domain into the signal in the time domain, and thereby obtains a PCM signal.

As described above, in the audio decoding apparatus, the signal characteristics are detected from the block shape representing the time/frequency conversion block length by the signal characteristic discrimination unit 51, it is discriminated whether the predicted precision in the time domain or the predicted precision in the frequency domain is high, and a quantization error of spectrum information obtained from the de-quantization by the signal correction unit 60 is corrected on the basis of the discrimination result.

Therefore, according to the audio decoding apparatus having the above-described configuration, if the signal has no continuity with an adjacent frequency band, the quantization error is corrected by the prediction in the time domain. Thus, a reproduced sound which is faithful to the original sound can be restored by suppressing an influence of noise generated at the time of decoding, for the signal having no continuity with a proximate frequency band.

In addition, since the audio decoder has the effect of making the encoded signal adjacent to the original signal to be encoded by correcting the quantization error, it is also effective as a pretreatment of analyzing the signal characteristics, such as detection of shout for joy, detection of music, and the like.

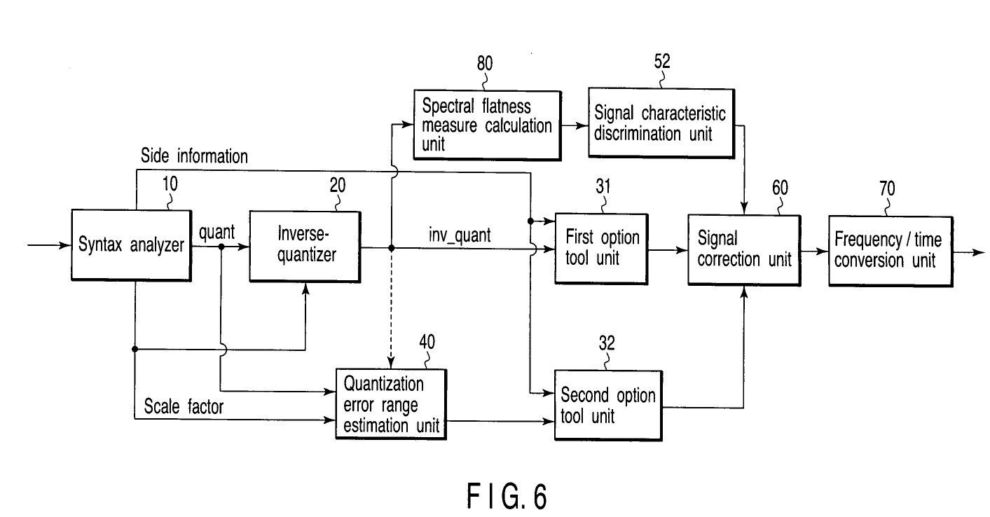

FIG. 6 shows a configuration of an audio decoding apparatus according to a second embodiment of the present invention.

The audio decoding apparatus comprises a syntax analyzer 10, an I-quantizer 20, a first option tool unit 31, a second option tool unit 32, a quantization error range estimation unit 40, a signal characteristic discrimination unit 52, a signal correction unit 60, a frequency/time conversion unit 70 and a spectral flatness measure calculation unit 80. In the following descriptions, AAC (Advanced Audio Coding) is employed as the encoding method, but the present invention can also be applied to an audio decoding apparatus employing the other general encoding systems.

The syntax analyzer 10 decodes an input bit stream to obtain the side information indicating the use of an option tool, the block shape and the like, and decodes the Huffman codes included in the bit stream to obtain a quantization spectrum (quant) generated by quantizing the original signal in each frequency band and a scale factor regarded as gain information representing the quantization step size of each spectrum.

The I-quantizer 20 inversely quantizes the quantization spectrum obtained by the syntax analyzer 10. In other words, the I-quantizer 20 extends the dynamic range by multiplying the quantization spectrum by the scale factor, and obtains spectrum information (inv_quant) having the dynamic range of the original signal (signal to be encoded). Since the operation principle of the I-quantizer 20 is the same as that of the I-quantizer 20 of the first embodiment, the explanation using the formula (1) is omitted here.

The first option tool unit 31 executes a joint stereo process such as M/S stereo, Intensity stereo, and the like and a process of TNS (cf. ISO/IEC 13818-7), for the spectrum information obtained by the de-quantization of the I-quantizer 20, on the basis of the side information obtained by the syntax analyzer 10.

The quantization error range estimation unit 40 calculates, for each frequency band, a level error range from the original signal (hereinafter called a quantization error range), as generated in the quantization spectrum at the quantization on the encoding apparatus, on the basis of the quantization spectrum in each of the frequency bands Huffman-decoded by the syntax analyzer 10 and the scale factor thereof. Since the operation principle of the quantization error range estimation unit 40 is the same as that of the quantization error range estimation unit 40 of the first embodiment, the explanations using the formula (2) to the formula (4) are omitted here.

The second option tool unit 32 executes a joint stereo process such as M/S stereo, Intensity stereo, and the like and a process of TNS (cf. ISO/IEC 13818-7), for the quantization error range obtained by the quantization error range estimation unit 40, on the basis of the side information obtained by the syntax analyzer 10.

The spectral flatness measure calculation unit 80 calculates a spectral flatness measure (hereinafter referred to as SFM) of the spectrum (inv_quant) obtained by the I-quantizer 20, in the following formula (8). In the formula (8), “inv_quant[i]” indicates a I-quantized MDCT coefficient and “n” indicates a frame size.

$$sfm = log ( \frac{Mg}{Ma} ) \\ where \\ Ma = \frac{{\sum }_{i = 0}^{n} inv\_quant [ i ]}{n} , \\ Mg = \sqrt[n]{inv\_quant [ 0 ] \times int\_quant [ 1 ] \times … \times inv\_quant [ n ]} \qquad ( 8 )$$

If the spectral flatness measure (SFM) calculated by the spectral flatness measure calculation unit 80 is greater than a preset threshold value TH1, the signal characteristic discrimination unit 52 discriminates that the signal characteristic of the current frame is transitional in the time domain. On the other hand, if the spectral flatness measure (SFM) is smaller than the preset threshold value TH1, the signal characteristic discrimination unit 52 discriminates that the signal characteristic of the current frame is stationary in the time domain. This is based on a fact that in general, the spectral flatness measure (SFM) tends to become greater as the signal is more transitional in the time domain. The signal characteristic discrimination unit 52 notifies the signal correction unit 60 of the discrimination result indicating the signal characteristic.

The signal correction unit 60 executes correction of the quantization error, for the signal output from the second option tool unit 32, on the basis of the signal characteristic obtained by the discrimination of the signal characteristic discrimination unit 52 and the quantization error range output from the second option tool unit 32. Since the operation principle of the signal correction unit 60 is the same as that of the signal correction unit 60 of the first embodiment, the explanations using the formula (5) to the formula (7) are omitted here.

The frequency/time conversion unit 70 converts the MDCT coefficient corrected by the signal correction unit 60 from the signal in the frequency domain into the signal in the time domain, and thereby obtains a PCM signal.

As described above, in the audio decoding apparatus, the signal characteristic is detected from the flatness measure of the quantized spectrum by the signal characteristic discrimination unit 52, it is discriminated whether the predicted precision in the time domain or the predicted precision in the frequency domain is high, and a quantization error of spectrum information obtained from the I-quantization by the signal correction unit 60 is corrected on the basis of the discrimination result.

Therefore, according to the audio decoding apparatus having the above-described configuration, if the signal has no continuity with an adjacent frequency band, the quantization error is corrected by the prediction in the time domain. Thus, a reproduced sound which is faithful to the original sound can be restored by suppressing an influence of noise generated at the time of decoding, for the signal having no continuity with a proximate frequency band.

In addition, since the audio decoding apparatus has the effect of making the encoded signal adjacent to the original signal to be encoded by correcting the quantization error, it is also effective as a pretreatment of analyzing the signal characteristics, such as detection of shout for joy, detection of music, and the like.

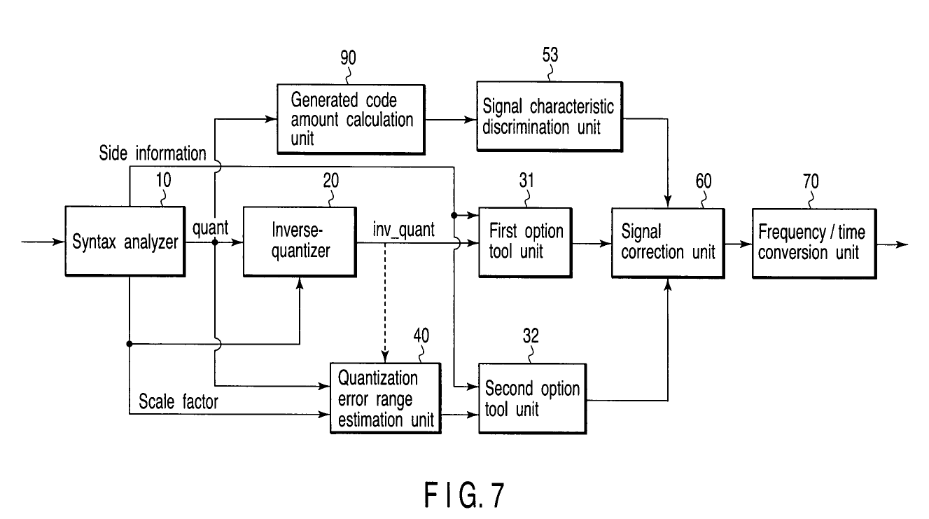

FIG. 7 shows a configuration of an audio decoding apparatus according to a third embodiment of the present invention. The audio decoding apparatus comprises a syntax analyzer 10, a I-quantizer 20, a first option tool unit 31, a second option tool unit 32, a quantization error range estimation unit 40, a signal characteristic discrimination unit 53, a signal correction unit 60, a frequency/time conversion unit 70 and a generated code amount calculation unit 90. In the following descriptions, AAC (Advanced Audio Coding) is employed as the encoding method, but the present invention can also be applied to an audio decoding apparatus employing the other general encoding method.

The syntax analyzer 10 decodes an input bit stream to obtain the side information indicating the use of an option tool, the block shape and the like, and decodes the Huffman codes included in the bit stream to obtain a quantization spectrum (quant) generated by quantizing the original signal for each frequency band and a scale factor regarded as gain information representing the quantization step size of each spectrum.

The I-quantizer 20 inversely quantizes the quantization spectrum obtained by the syntax analysis unit 10. In other words, the I-quantizer 20 extends the dynamic range by multiplying the quantization spectrum by the scale factor, and obtains spectrum information (inv_quant) having the dynamic range of the original signal (signal to be encoded). Since the operation principle of the I-quantizer 20 is the same as that of the I-quantizer 20 of the first embodiment, the explanation using the formula (1) is omitted here.

The first option tool unit 31 executes a joint stereo process such as M/S stereo, Intensity stereo, and the like and a process of TNS (cf. ISO/IEC 13818-7), for the spectrum information obtained by the de-quantization of the I-quantizer 20, on the basis of the side information obtained by the syntax analyzer 10.

The quantization error range estimation unit 40 calculates, for each frequency band, a level error range from the original signal (hereinafter called a quantization error range), as generated in the quantization spectrum at the quantization on the encoding apparatus, on the basis of the quantization spectrum in each of the frequency bands Huffman-decoded by the syntax analyzer 10 and the scale factor thereof. Since the operation principle of the quantization error range estimation unit 40 is the same as that of the quantization error range estimation unit 40 of the first embodiment, the explanations using the formula (2) to the formula (4) are omitted here.

The second option tool unit 32 executes a joint stereo process such as M/S stereo, Intensity stereo, and the like and a process of TNS (cf. ISO/IEC 13818-7), for the quantization error range obtained by the quantization error range estimation unit 40, on the basis of the side information obtained by the syntax analyzer 10.

The generated code amount calculation unit 90 calculates generated code amount B of each frame, on the basis of the quantization spectrum (quant) obtained by the syntax analyzer 10.

If the generated code amount B calculated by the generated code amount calculation unit 90 is greater than a preset threshold value TH2, the signal characteristic discrimination unit 53 discriminates that the signal characteristic of the current frame is transitional in the time domain. On the other hand, if the generated code amount B is smaller than the preset threshold value TH2, the signal characteristic discrimination unit 53 discriminates that the signal characteristic of the current frame is stationary in the time domain. This is based on a fact that in general, more bits tend to be required when the transitional signal is encoded in the time domain. The signal characteristic discrimination unit 53 notifies the signal correction unit 60 of the discrimination result indicating the signal characteristic.

The threshold value TH2 is determined on the basis of the sampling frequency, average bit rate (kbps), and the like. For example, the average code amount per frame may be obtained dynamically in the following formula (9) and employed as the threshold value TH2.

TH2=bitrate×frame_size/Fs (9)

In the formula (9), “bit rate” indicates the average bit rate (bps), “frame_size” indicates the frame size to encode, and “Fs” indicates the sampling frequency (Hz). However, a method of setting the threshold value TH2 is not limited to the formula (9), but can be arbitrarily changed within a scope which does not exceed the idea of associating the generated code amount with the stationary characteristic of the signal.

The signal correction unit 60 executes correction of the quantization error, for the signal output from the second option tool unit 32, on the basis of the signal characteristic obtained by the discrimination of the signal characteristic discrimination unit 53 and the quantization error range output from the second option tool unit 32. Since the operation principle of the signal correction unit 60 is the same as that of the signal correction unit 60 of the first embodiment, the explanations using the formula (5) to the formula (7) are omitted here.

The frequency/time conversion unit 70 converts the MDCT coefficient corrected by the signal correction unit 60 from the signal in the frequency domain into the signal in the time domain, and thereby obtains a PCM signal.

As described above, in the audio decoding apparatus, the signal characteristic is detected from the generated code amount by the signal characteristic discrimination unit 53, it is discriminated whether the predicted precision in the time domain or the predicted precision in the frequency domain is high, and a quantization error of spectrum information obtained from the I-quantization by the signal correction unit 60 is corrected on the basis of the discrimination result.

Therefore, according to the audio decoding apparatus having the above-described configuration, if the signal has no continuity with an adjacent frequency band, the quantization error is corrected by the prediction in the time domain. Thus, a reproduced sound which is faithful to the original sound can be restored by suppressing an influence of noise generated at the time of decoding, for the signal having no continuity with a proximate frequency band.

In addition, since the audio decoding apparatus has the effect of making the encoded signal adjacent to the original signal to be encoded by correcting the quantization error, it is also effective as a pretreatment of analyzing the signal characteristics, such as detection of shout for joy, detection of music, and the like.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the MDCT coefficient of the current frame is predicted by the linear prediction. However, a method of prediction based on the stationary characteristic of the time series is not limited to the above-described embodiments, but the other methods can be employed within the scope which does not exceed this gist.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An audio decoding apparatus, comprising:
a decoding unit which decodes encoded audio data and obtains quantization spectrum, information containing a quantization step size, and a spectral value;
a discrimination unit which discriminates a signal characteristic of a time domain of the spectral value;
a I-quantizer which inversely quantizes the quantization spectrum and obtains the spectral value;
an estimation unit which estimates a range of a level of the spectral value, based on the quantization step size and the spectral value;
a correction unit which corrects the spectral value within the range with reference to continuity in time of the spectral value if the discrimination unit discriminates that the signal characteristic in the time domain is stationary, and which corrects the spectral value within the range with reference to continuity in frequency of the spectral value if the discrimination unit discriminates that the signal characteristic in the time domain is transitional; and
a conversion unit which converts the spectral value corrected by the correction unit into a signal in the time domain.

2. The audio decoding apparatus according to claim 1, wherein the discrimination unit discriminates the signal characteristic of the spectral value from information which is included in the encoded audio data and which indicates a frame size, and
the correction unit corrects the spectral value within the range with reference to the continuity in time of the spectral value if the discrimination unit discriminates that the frame size is equal to or greater than a preset threshold value and that the signal characteristic in the time domain is stationary, and which corrects the spectral value within the range with reference to the continuity in frequency of the spectral value if the discrimination unit discriminates that the frame size is smaller than the preset threshold value and that the signal characteristic in the time domain is transitional.

3. The audio decoding apparatus according to claim 1, wherein the discrimination unit detects a flatness measure of a spectral shape from information on the spectral value, and
the correction unit corrects the spectral value within the range with reference to the continuity in time of the spectral value if the flatness measure detected by the discrimination unit is smaller than a preset threshold value and if the discrimination unit discriminates that the signal characteristic in the time domain is stationary, and which corrects the spectral value within the range with reference to the continuity in frequency of the spectral value if the flatness measure detected by the discrimination unit is equal to or greater than the preset threshold value and if the discrimination unit discriminates that the signal characteristic in the time domain is transitional.

4. The audio decoder according to claim 1, wherein the discrimination unit detects a generated code amount for each frame from the information on the spectral value, and
the correction unit corrects the spectral value within the range with reference to the continuity in time of the spectral value if the generated code amount detected by the discrimination unit is smaller than a preset threshold value and if the discrimination unit discriminates that the signal characteristic in the time domain is stationary, and which corrects the spectral value within the range with reference to the continuity in frequency of the spectral value if the generated code amount detected by the discrimination unit is equal to or greater than the preset threshold value and if the discrimination unit discriminates that the signal characteristic in the time domain is transitional.

5. The audio decoding apparatus according to claim 1, wherein the estimation unit substitutes the information on the spectral value into a formula by which a quantization formula of the encoded audio data is differentiated with respect to a parameter indicating a quantization value, and estimates the range of the level of the spectral value, in accordance with a result of the substitution, the information on the quantization step size and the spectral value.

6. An audio decoding method, comprising:
decoding encoded audio data to obtain information on a quantization step size and obtaining quantization spectrum, information containing a quantization step size, and a spectral value;
discriminating a signal characteristic of a time domain of the spectral value;
inversely quantizing the quantization spectrum and obtaining the spectral value;
estimating a range of a level of the spectral value based on the quantization step size and the spectral value;
correcting the spectral value within the range with reference to continuity in time of the spectral value if it is discriminated in the discrimination step that the signal characteristic in the time domain is stationary, and correcting the spectral value within the range with reference to continuity in frequency of the spectral value if it is discriminated in the discrimination step that the signal characteristic in the time domain is transitional; and
converting the spectral value corrected in the correction step into a signal in the time domain.

7. The method according to claim 6, wherein in the discrimination step, the signal characteristic of the spectral value is discriminated from information which is included in the encoded audio data and which indicates a frame size, and
in the correction step, the spectral value is corrected within the range with reference to continuity in time of the spectral value if it is discriminated in the discrimination step that the frame size is equal to or greater than a preset threshold value and that the signal characteristic in the time domain is stationary, and the spectral value is corrected within the range with reference to continuity in frequency of the spectral value if it is discriminated in the discrimination step that the frame size is smaller than the preset threshold value and that the signal characteristic in the time domain is transitional.

8. The method according to claim 6, wherein in the discrimination step, a flatness measure of a spectral shape is detected from information on the spectral value, and
in the correction step, the spectral value is corrected within the range with reference to continuity in time of the spectral value if the flatness measure detected in the discrimination step is smaller than a preset threshold value and if it is discriminated in the discrimination step that the signal characteristic in the time domain is stationary, and the spectral value is corrected within the range with reference to continuity in frequency of the spectral value if the flatness measure detected in the discrimination step is equal to or greater than the preset threshold value and if it is discriminated in the discrimination step that the signal characteristic in the time domain is transitional.

9. The method according to claim 6, wherein in the discrimination step, a generated code amount for each frame is detected from the information on the spectral value, and
in the correction step, the spectral value is corrected within the range with reference to continuity in time of the spectral value if the generated code amount detected in the discrimination step is smaller than a preset threshold value and if it is discriminated in the discrimination step that the signal characteristic in the time domain is stationary, and the spectral value is corrected within the range with reference to continuity in frequency of the spectral value if the generated code amount detected in the discrimination step is equal to or greater than the preset threshold value and if it is discriminated in the discrimination step that the signal characteristic in the time domain is transitional.

10. The method according to claim 6, wherein in the estimation step, the information on the spectral value is substituted into a formula by which a quantization formula of the encoded audio data is differentiated with respect to a parameter indicating a quantization value, and the range of the level of the spectral value is estimated in accordance with a result of the substitution, the information on the quantization step size and the spectral value.
